(19) United States
(12) Patent Application Publication
(10) Pub. No.: US 2025/0356557 A1
(43) Pub. Date: Nov. 20, 2025

(54) REAL-TIME, HIGH-RESOLUTION AND GENERAL NEURAL VIEW SYNTHESIS

(71) Applicant: Google LLC, Mountain View, CA (US)

(72) Inventors: Clément Louis Jean-Claude Godard, San Francisco, CA (US); John Patrick Flynn, Los Angeles, CA (US); Kathryn Heal, Los Angeles, CA (US); Kira Mathias-Prabhu, Reading (GB); Lucy Rong Chai, Orange, CA (US); Lukas Murmann, San Mateo, CA (US); Lynn Tsai, Seattle, WA (US); Michael Joseph Broxton, Los Gatos, CA (US); Srinivas Kaza, Cambridge, MA (US); Stephen Anthony Lombardi, Seattle, WA (US); Supreeth Achar, Seattle, WA (US); Tiancheng Sun, Kirkland, WA (US); Xuan Luo, Seattle, WA (US)

(21) Appl. No.: 19/212,396

(22) Filed: May 19, 2025

Related U.S. Application Data
(60) Provisional application No. 63/649,430, filed on May 19, 2024.

(51) Int. Cl. G06T 11/60; G06T 5/50; G06T 7/55; G06T 9/00; G06V 10/771

(52) U.S. Cl. CPC G06T 11/60; G06T 5/50; G06T 7/55; G06T 9/00; G06V 10/771; G06T 2207/20016; G06T 2207/20221

(57) ABSTRACT

A method including generating a plurality of feature maps based on a plurality of images triggered to capture at a same time, the plurality of images having a plurality of view perspectives, generating a layered depth map based on the plurality of feature maps, and generating an image based on the layered depth map and the plurality of images, the image having a view perspective not included in the plurality of view perspectives.

### CROSS-REFERENCE TO RELATED APPLICATION

This application claims priority to U.S. Provisional Patent Application No. 63/649,430, filed on May 19, 2024, the disclosure of which is incorporated by reference herein in its entirety.

### BACKGROUND

Image and/or video synthesis can include generating one image and/or one video based on multiple images or videos. Novel view synthesis can use multiple images or videos taken from different view perspectives as input and use neural models to interpolate the view perspectives associated with multiple images or videos into a novel (or new) view perspective.

### SUMMARY

Some implementations can be configured to perform a reconstruction operation and a rendering operation for novel view synthesis in a combined process.

In a general aspect, a device, a system, a non-transitory computer-readable medium (having stored thereon computer executable program code which can be executed on a computer system), and/or a method can perform a process with a method including generating a plurality of feature maps based on a plurality of images triggered to capture at a same time, the plurality of images having a plurality of view perspectives, generating a layered depth map based on the plurality of feature maps, and generating an image based on the layered depth map and the plurality of images, the image having a view perspective not included in the plurality of view perspectives.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1 illustrates a novel view or view perspective image generation according to an example implementation.

FIG. 2 illustrates a block diagram of data flow (or pipeline) associated with streaming and generating a video according to an example implementation.

FIGS. 3A and 3B illustrate block diagrams of a dataflow according to an example implementation.

FIGS. 4A and 4B illustrate block diagrams of a model according to an example implementation.

FIGS. 5A, 5B, and 5C illustrate block diagrams of a dataflow associated with the update and fuse operation of FIG. 3B according to an example implementation.

FIG. 6 illustrates a block diagram of method of synthesizing an image according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Novel view synthesis can include generating or synthesizing a single video using video captured by multiple cameras. This single video can be displayed (or rendered for display) on a display. The video is generated having a novel (e.g., new) view perspective in respect to some content of the video. The novel view perspective is not the same (or substantially equivalent to) any of the view perspectives associated with the multiple cameras used to capture the video. Accordingly, generating the single video can include generating the single video based on the video captured by the multiple cameras and with the novel view perspective.

Novel view synthesis can include multiple learned solutions that provide high quality, photorealistic results. Novel view synthesis can use multiple images or videos taken from different view perspectives as input and use neural or conventional structure-from- motion models to interpolate the view perspectives associated with multiple images or videos into a novel (or new) view perspective. The quality afforded by these approaches is suitable for their use in real-world applications including, for example, re-rendering an environment with different climate, text-to-3D asset creation, simultaneous localization and mapping (SLAM), and the like. Some application opportunities for novel view synthesis include real-time streaming. For example, live streaming events for real-time free-viewpoint video, 3D telepresence to replace 2D video conferencing, photorealistic 3D cloud gaming, robotics applications, and the like.

At least one technical problem with existing video streaming pipelines is that real-time view synthesis that uses multiple video streams to generate real-time video can be too slow to provide a desirable experience. For example, existing techniques generally require two operations to generate novel views of a scene. First, the existing techniques perform an optimization procedure to reconstruct a 3D physical representation. Second, the 3D representation is rendered from a novel view. While some approaches can perform the rendering operation in real-time, the reconstruction operation remains too slow to provide a desirable experience. At least one technical solution can be to perform reconstruction and rendering in a combined process. In some implementations, the combined process can use a machine learned model. At least one technical effect of the technical solution can be to improve a user's experience by providing real-time view synthesis at the rate and quality expected for live streaming events, e.g., 3D telepresence and video conferencing.

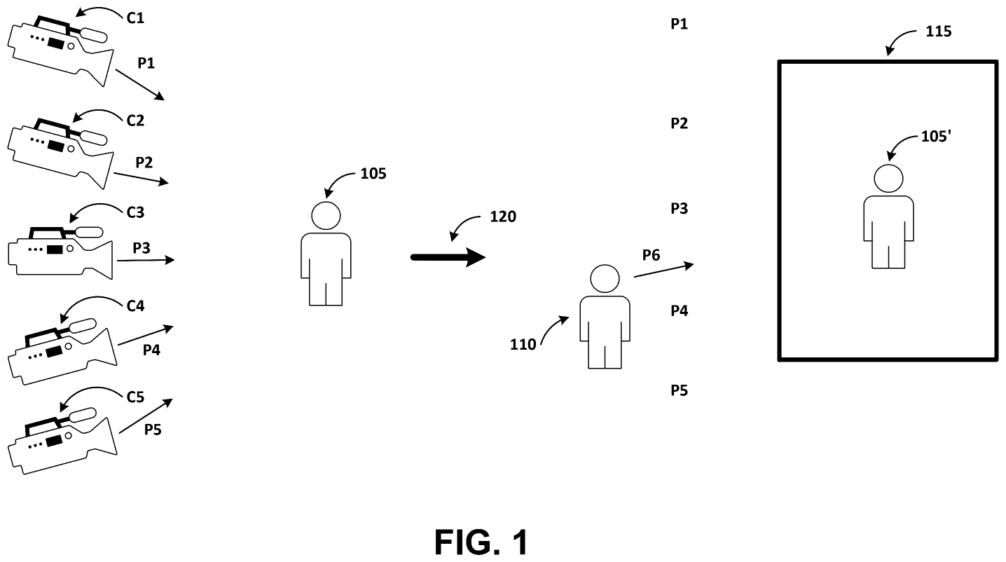

FIG. 1 illustrates a novel (e.g., new or not captured using a camera) view or view perspective image generation or image synthesis example according to an example implementation. As shown in FIG. 1, cameras (e.g., two or more cameras, a plurality of cameras, and the like) C1, C2, C3, C4, C5, can be used (e.g., each can be used) to capture an image and/or a video (e.g., frames of a video). The video can be of a scene, an object, an event, a person(s), and/or the like). For example, FIG. 1 illustrates cameras C1, C2, C3, C4, C5 being used to capture a video of a person 105.

Cameras C1, C2, C3, C4, C5 can capture video from a view perspective (sometimes referred to as a view). For example, camera C1 can have view perspective P1, camera C2 can have view perspective P2, camera C3 can have view perspective P3, camera C4 can have view perspective P4, and camera C5 can have view perspective P5. In the example of FIG. 1, five (5) cameras having respective view perspectives are illustrated. However, any number of camera(s) having a respective view perspective(s) can be used and are within the scope of this disclosure.

In some implementations, the video can be associated with a plurality of images or plurality of frames. In some implementations, the plurality of images can be triggered to capture substantially simultaneously. In some implementations, the plurality of images can be triggered to capture simultaneously. In some implementations, the plurality of images can be captured substantially at the same time. In some implementations, the plurality of images can be captured at the same time. In some implementations, the plurality of images can be captured substantially simultaneously. In some implementations, the plurality of images can be captured simultaneously. For example, the system including the plurality of cameras can trigger the sending of an instruction to a plurality of cameras at substantially the same time. The instruction can cause each of the plurality of cameras to capture an image. Accordingly, the plurality of cameras can be configured to capture a plurality of images at the same time based on the trigger. In other words, cameras C1, C2, C3, C4, C5 can be configured to capture a plurality of images at the same time (simultaneously, substantially simultaneously) based on (in response to) the trigger.

In some implementations, during playback of the video captured by cameras C1, C2, C3, C4, C5, a single video can be generated or synthesized using the video captured by cameras C1, C2, C3, C4, C5. This single video can be displayed (or rendered for display) on display 115. The video is generated having a view perspective P6 in respect to user 110 (the viewer of the video). However, as shown in FIG. 1, view perspective P6 is not the same (or substantially equivalent to) any of the view perspectives P1, P2, P3, P4, P5. Therefore, view perspective P6 is a new or novel view perspective. Accordingly, generating the video (including person 105′) can include generating the video with view perspective P6.

In some implementations, the video captured by cameras C1, C2, C3, C4, C5 can be streamed from a local device to a remote device (e.g., respective computer devices). In some implementations, the video captured by cameras C1, C2, C3, C4, C5 can be streamed as individual video streams. Arrow 120 represents streaming (e.g., as individual streams) the video captured by cameras C1, C2, C3, C4, C5 from a local device to a remote device.

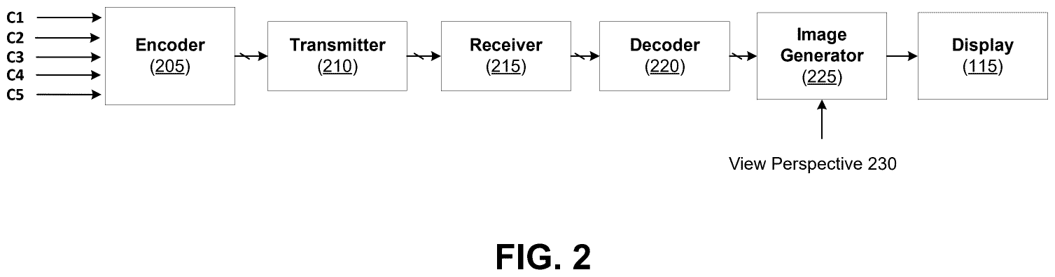

FIG. 2 illustrates a data flow (or pipeline) associated with streaming and generating a video according to an example implementation. As shown in FIG. 2, the data flow includes an encoder 205, a transmitter 210, a receiver 215, a decoder 220, an image generator 225 and the display 115. In some implementations, encoder 205 can be configured to compress the video captured by cameras C1, C2, C3, C4, C5 (e.g., compress each of the video captured by cameras C1, C2, C3, C4, C5 individually). Encoder 205 can use any compression scheme or codec. For example, encoder 205 can use a high efficiency video coding (HVEC) video codec or standard. Decoder 220 can be configured to perform the inverse of encoder 205. In other words, decoder 220 can be configured to decompress the compressed video. In some implementations, the decoder 220 can be configured to decompress individual streams. In some implementations, the decoder 220 can be configured to generate reconstructed video representing the video captured by cameras C1, C2, C3, C4, C5.

Transmitter 210 and receiver 215 together provide the functionality to stream video. In some implementations, the transmitter 210 can be an element of a local device and the receiver 215 can be an element of a remote device. In some implementations, the transmitter 210 can be an element of a first edge node in a network and the receiver 215 can be an element of a second edge node in the network. In some implementations, transmitter 210 can be configured to generate packet(s) including video to be communicated using a (e.g., wired or wireless) communications standard. In some implementations, receiver 215 can be configured to unpack video from the packet(s) including video.

Image generator 225 can be configured to generate an image, a video, a frame of the video, and/or the like based on a plurality of images, videos, frames of the videos, and/or the like. Image generation is sometimes referred to as image synthesis. Video generation is sometimes referred to as video synthesis. Video frame generation is sometimes referred to as video frame synthesis. In some implementations, image generator 225 can be configured to generate video based on reconstructed video representing the video captured by cameras C1, C2, C3, C4, C5. In some implementations, image generator 225 can be configured to generate video having a new or novel view perspective. In some implementations, image generator 225 can be configured to generate video having a new or novel view perspective based on view perspective 230.

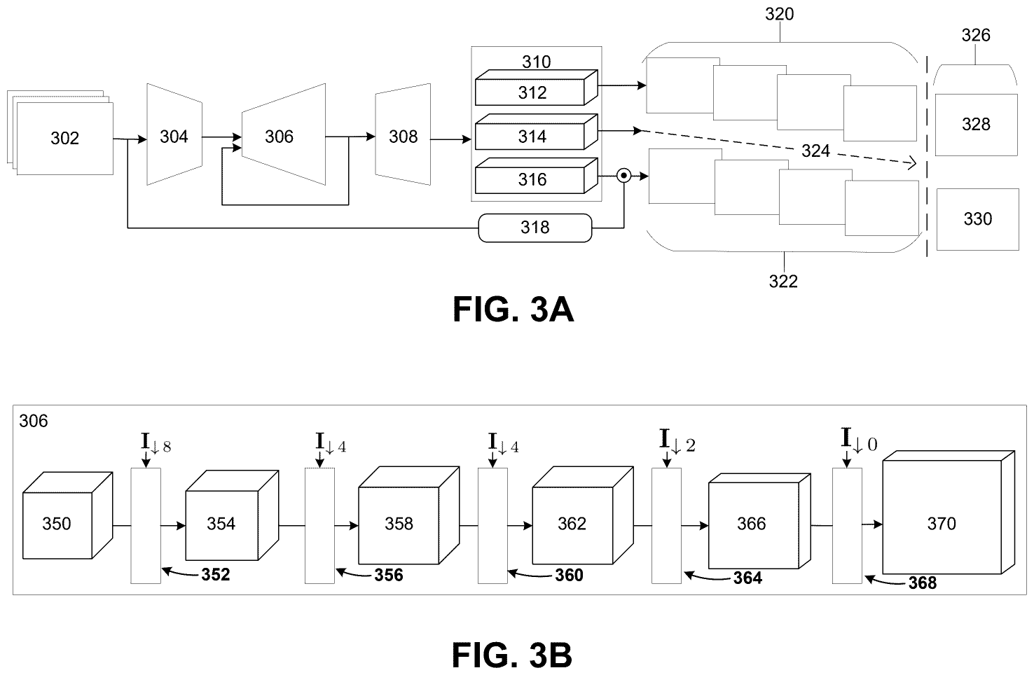

Some implementations present a neural model that achieves real-time rates for reconstruction and rendering combined (see FIGS. 3A and 3B). Some implementations include a model (e.g., a machine learned model) that can take as input an array of wide baseline high-resolution images or video streams and produces high-quality novel view renderings. Some implementations can use, for example, eight (8) input images per frame that are as far as 30 cm apart. Some implementations demonstrate that the example model can produce novel views at 30 fps at 1080 p (1920 1080) resolution on a GPU. Through thorough qualitative and quantitative analysis, some implementations demonstrate state-of-the-art quality at real-time rates.

Some display end-points, such as smartphones or standalone virtual reality (VR) headsets, lack the compute resources to be able to run some of the techniques described herein. Therefore, some implementations can use a streaming cloud architecture. For example, referring to FIG. 2, the receiver 215, the decoder 220, and the image generator 225 can be performed using a streaming cloud architecture. In this case, another encoder, transmitter, receiver, decoder pipeline (not shown) would be included between the image generator 225 and the display 115.

In such an architecture, some implementations can be configured to stream multiple (e.g. 4-8) high resolution streams from an input camera rig to a display device and/or a host device in the cloud. At higher resolutions (e.g. 4K), this could amount to over 200 Mbps of upstream bandwidth using standard video codecs which would be impractically expensive for a large proportion of locations. Fortunately, these input streams represent different views of the same object. Therefore, this bandwidth can be reduced by exploiting redundancy between views. Moreover, depending on the specific view synthesis method, regions of the input views that are not visible from the target may not be sent over the network, further reducing bandwidth.

Some implementations are trained end-to-end from a lightweight preprocessor network, through the compression model, and to the outputs of novel view synthesis, and back propagate gradients back to the preprocessor. In some implementations, this allows the preprocessor network to learn which regions of the upstream images provide useful information to the view synthesis network and instruct the codec to heavily compress unimportant regions. In some implementations, these regions tend to be redundant between streams or less necessary for high-quality texture synthesis from the novel view synthesis network. In some implementations, the potential bandwidth savings are even greater if only the foreground needs to be displayed. Some implementations achieve end-to-end training by incorporating a differentiable codec proxy that mimics the performance of the real codec. During inference, some implementations replace the differentiable codec proxy with the real codec hardware.

In some implementations, this joint compress-and-reconstruct training procedure is a shift away from hand-crafted compression procedures intended to minimize distortion in the inputs of view synthesis. Some system implementations can be configured to learn to compress video for view synthesis, and can be optimized to minimize the distortion incurred in the rendered output of the view synthesis method while maintaining a high, user-configurable compression ratio.

Some implementations take a set of multi-view images or video streams and reconstruct a compact layered depth map (LDM) representation that is used to perform image-based rendering. Network inference can be fast. For example, scene reconstruction and rendering combined can run at 30 fps on a single graphics processing unit (GPU) at 1080 p (1920 1080) resolution. Thus, enabling an example model to perform high quality novel view synthesis on-demand for a dynamic viewpoint even for scenes with moving content. During each time step the network can create a pyramid of downsampled and encoded input images using scalar downsampling factors k and then infers an LDM in the frustum of the novel viewpoint through a series of n. Update and fuse operations can use across-view attention to fuse information from multiple input views. This iterative, multi-scale approach can save computer resources by gradually increasing spatial resolution while decreasing layer count. A final bilinear upsample by a scalar factor of s followed by non-linear feature activation is used to produce an LDM at the final output resolution.

Some implementations describe a neural model for performing high-quality, high-resolution, real-time novel view synthesis. From a sparse set of input RGB (red, green, blue) images or video streams. An example network or model can both reconstruct the three- dimensional (3D) scene and render novel views at 1080 p resolution at 30 fps on a GPU. Some implementations include a feed-forward network that generalizes across a wide variety of datasets and scenes and produces state-of-the-art quality for a real-time method. Some implementations have quality approaches that in some cases surpass the quality of some of the top offline methods. In order to achieve these results some implementations use a novel combination of several concepts and tie them together into a cohesive and effective model. Some implementations can represent the scene using semi-transparent layers and use an iterative learned render-and-refine approach to improve those layers. Instead of flat layers, some implementations include a method that can reconstruct layered depth maps that efficiently represent scenes with complex depth and occlusions. The iterative update operations are embedded in a multi-scale, for example, UNet-style architecture to perform as much computing as possible at reduced resolution. Within each update operation, to better aggregate the information from multiple input views, some implementations use a specialized Transformer-based network component. This allows most of the per-input image processing to be performed in the input image space, as opposed to layer space, further increasing efficiency. Finally, due to the real-time nature of Some implementations reconstruct and render, to dynamically create and discard the internal 3D geometry for each frame, optimizing the LDM for each view. Taken together, this generates an effective model for view synthesis.

FIGS. 3A and 3B illustrate a dataflow according to at least one example implementation. As shown in FIG. 3A, the data flow includes an encoder 304 block that receives a plurality of frames of video 302 each having a view perspective. For example, as described above with regard to FIG. 1, video 302 can be video captured by cameras C1, C2, C3, C4, C5 each having a respective view perspective P1, P2, P3, P4, P5. The encoder 304 can be configured to generate a feature map I_{↓k} for each frame. The video 302 can have matrix dimensions [M, H, W, C] where M is the number of input images for each layer, H is height of an input image, W is width of an input image, and C is channel count. The channel count can be associated with the number of frames, view perspectives, cameras, and the like. In FIG. 1, C=5, and in FIG. 3A, C=3.

As shown in FIG. 3A, the data flow includes an iterative update 306 block that receives the feature map I_{↓k} for each frame. Iterative update 306 can be configured to use across-view attention to fuse information from multiple input views. This iterative, multi-scale approach can save compute resources by gradually increasing spatial resolution while decreasing layer count. Iterative update 306 is described below in FIG. 3B.

As shown in FIG. 3A, the data flow includes an upsample and activate 308 block. Upsample and activate 308 can be configured to upsample the layered depth map (LDM) generated by iterative update 306. Upsample and activate 308 can be a bilinear upsample by a scalar factor of s. The resultant LDM 310 can include depth 312, density 314, and blended weights 316. Depth 312 can have dimensions [L, H, W, 1] where L is the number of layers, H is height of a depth map, W is width of a depth map, and 1 channel. Density 314 can have dimensions [L, H, W, 1] where L is the number of layers, H is height of a depth map, W is width of a depth map, and 1 channel. Blended weights 316 can have dimensions [L, H, W, M] where L is the number of layers, H is height of a depth map, W is width of a depth map, and M is the number of maps for each layer.

As shown in FIG. 3A, the data flow includes blocks representing depth layers 320, blocks representing blended image layers 322, and arrow 324 representing over-composite LDM layers back to front. Novel view 326 can have dimensions [H, W, C] where H is height of an image, W is width of an image, and C is channel count C=3 in FIG. 3A). Novel view 326 can include a depth map 328 and a rendered image 330. The depth map 328 and rendered image 330 can have a novel or new view perspective. The depth map 328 can be generated based on depth layers 320. The rendered image 330 can be generated based on blended image layers 322. Blended image layers 322 can be generated based on blend weights 316 and the plurality of frames of video 302.

As shown in FIG. 3B, iterative update 306 can include an initialization 350 block and update and fuse 352, 356, 360, 364, 368 blocks. The update and fuse 352, 356, 360, 364, 368 operation can be configured to generate a feature volume 354, 358, 362, 366, 370 block. In some implementations, feature volume 354, 358, 362, 366, 370 can be referred to as a refined feature volume.

Initialization 350 can be configured to use a special case of the update and fuse operation. Initially, there is no existing LDM to use as input to the first iteration. Therefore, some implementations start with a single learned C-channel feature broadcasted to initial spatial dimensions H⁽⁰⁾, W⁽⁰⁾. The first update and fuse operation assumes depth layers are flat (e.g., initialized to the depth anchor values defined below), and thus it only combines image features Iₖ and ray directions γₖ.

During each iteration, the update and fuse 352, 356, 360, 364, 368 operation can be configured to use a render-and-refine approach to generate a refined feature volume 354, 358, 362, 366, 370. First, the feature volume 354, 358, 362, 366, 370 can be decoded into an LDM and rendered M times into each of the input viewpoints. Next, the rendered features can be combined with input features Iₖ and encoded ray directions γₖ via a residual, for example, feed-forward convolutional neural network (CNN) to generate updated features from each view. During iterations where the feature volume 354, 358, 362, 366, 370 can be upscaled, the rendered intermediate LDM can be upsampled by a factor of, for example, two in the spatial dimension and combined with image features at the next level of detail. Updated features can be back-projected into the feature volumes using the same depths d decoded in the rendered input views. Finally, updates from all (or substantially all) views can be combined into a single set of update features Δ and fused, which uses across-view attention to reason about visibility and update the feature volume. Note that multiple update and fuse 352, 356, 360, 364, 368 operations can be used during each iteration. Layer collapse, which reduces the number of layers by, for example, a factor of 2 via, for example, a residual CNN, can also be applied during the final two iterations.

Some implementations present a neural model that achieves real-time rates for reconstruction and rendering combined. As shown in FIGS. 3A and 3B, some implementations include a model (e.g. machine learned model) that can take as input an array of wide baseline high-resolution images or video streams (e.g., video 302) and produces high-quality novel view renderings (e.g., rendered image 330). Some implementations can use, for example, eight (8) input images per frame that are as far as 30 cm apart. Some implementations demonstrate that the example model can produce novel views at, for example, 30 fps at 1080 p (1920 1080) resolution on a GPU. Through thorough qualitative and quantitative analysis, some implementations demonstrate state-of-the-art quality at real-time rates. In some implementations, quality can approach offline methods, and in some cases surpass them. Some example networks can be highly tunable and can achieve even higher quality if slower (e.g. 10 fps) rendering is acceptable.

Some implementations combine several key concepts that are described with regard to FIGS. 3A and 3B. As depicted in FIG. 3A some implementations can make use of a layered depth map (LDM) 3D scene representation (e.g., LDM 310). The output LDM can use a small number (e.g., 6) of layers, each with an associated depth map (depth 312), density map (density 314), and blend weights (blended weights 316). The depth map geometry can conform to objects in the scene, the density map can model occlusions and anti-aliased edges, and the blend weights can blend over the input image pixels to produce high-resolution output images. In some implementations, the LDM can be closely related to a layered mesh (LM). However, some implementations do not instantiate a mesh from example depth maps.

Moreover, some implementations can include a method that can reconstruct, render, and discard the LDM for every frame. Hence, some implementations can optimize the LDM to each specific novel view in a video sequence, aligning it with the view. Therefore, generating depth, density, and blend weights that are optimized for that view and rendering with a simple pixel-aligned over operation. As demonstrated in some example results this can help for scenes with reflective and refractive materials which some implementations LDM representation may not model explicitly.

In order to create an efficient network to solve the LDM for each frame, some implementations can use a multi-scale learned render-and-refine network structure as highlighted in FIG. 3B. The learned render-and-refine approach is similar to an unrolled gradient descent but with dramatically faster convergence properties (e.g. 5 iterations instead of thousands). As described below, in each update and fuse 352, 356, 360, 364, 368 operation in FIG. 3B the network can render the current LDM estimate to each of the input views, and use the result to refine the LDM.

Some implementations include a learned render-and-refine approach real-time, which some implementations achieve by embedding the update and fuse 352, 356, 360, 364, 368 operations into, for example, a UNet structure. As shown in FIG. 3B, initialization 350 can initialize the encoded image features. For example, different resolutions can be generated through a series of strided convolutions, mean pooling and/or by resizing. In some implementations, the different resolutions may have different numbers of features. Then the first update and fuse 352 operation starts at the lowest, aggressively down-scaled resolution. Each successive update and fuse 356, 360, 364, 368 operation improves the LDM solution, while some increase the spatial resolution (the update and fuse 352, 360, 364 operations in FIG. 3B) and some decrease the number of LDM layers (the last two update and fuse 364, 368 operations in FIG. 3B). In some implementations, the number of layers progresses from high to low because the depth dimension for most scenes can be represented by a small number of impulses (surfaces). In some implementations, the number of layers progresses from high to low because the depth dimension for most scenes can be represented by a small number of layers. The denser depth sampling at early iterations locates those surfaces, and the fewer layers at later iterations more closely follow them.

To further optimize the network, the final update and fuse 368 operation generates an LDM at a reduced resolution (scaling factor s in FIG. 3B which is, for example 2 to 4), and some implementations upscale the unactivated LDM 310 attributes (depth 312, density 314, and blend weights 316) with a bilinear upsample followed by an activation (upsample and activate 308 in FIG. 3A). This approach has been demonstrated to be effective for piecewise smooth functions. Some implementations have LDM 310 attributes that interpolate the smooth regions while maintaining sharp edges.

A problem in view synthesis is how to aggregate information from multiple views in an efficient and order-independent manner. As described below, some implementations include a method that solves this by incorporating a Transformer based network component within each update and fuse 352, 356, 360, 364, 368 operation. Some implementations introduce an optimized variant of cross-attention, one-to-many attention, that dramatically lowers computational requirements.

Some implementations additionally show how to replace a transformer's traditional positional encoding with a directional encoding based on the pose of the input images. When taken together, these, along with many other smaller design choices fully described below and justified with extensive ablations shown below, produce a model that produces high-quality synthesized images at real-time rates as demonstrated by example results below.

The quality of view synthesis algorithms is highly dependent on the accuracy of their physical representation. Recent view synthesis approaches use a wide variety of representations, including implicit surfaces, point clouds, voxels, 3D Gaussians, triangle surface meshes, message passing interfaces (MPIs), multi-sphere images (MSIs), layered meshes (LMs), and volumetric ray marches of neural fields.

Some implementations use an LDM representation which is similar to an LM. LMs also internally solve a LDM and then map to a LM in order to cleanly reproject to other views. However, some implementations can render the LDM directly without a mesh. LDMs (and LMs) combine the quality of fully volumetric representations and the efficiency of surfaces. The layers can be considered steps of a volumetric ray march. Simultaneously, the depth map within each layer follows the smooth surfaces that make up the largest portion of real-world scenes.

While a physical representation can determine the asymptotic quality limit of an approach to novel view synthesis, the model that generates the representation determines both how closely it approaches that limit and the overall speed. As described below, some implementations use an architecture compared to other neural rendering networks. This architecture is designed for (1) efficiency, specifically during the scene reconstruction, and (2) generalizability, to reconstruct a broad range of scenes using wide camera baselines.

In FIG. 3A, the pixel colors and ray directions in video 302 (sometimes called input views) are first encoded using encoder 304 into a feature pyramid. A feature pyramid can be feature extractor that takes a single-scale image of an arbitrary size as input and generates proportionally sized feature maps at multiple levels, in a fully convolutional fashion. The feature pyramid can be input into iterative update 306. Iterative update 306 can use, a series of multi-scale update and fuse 352, 356, 360, 364, 368 operation which refine the LDM progressing from low resolution to high resolution while also reducing the number of LDM layers. Within each update and fuse 352, 356, 360, 364, 368 operation (shown in detail in FIG. 3B), the LDM is rendered to the input views (Render to Input Views) and the results fused (One-to-many Attention) in order to guide the update of the LDM. The final update and fuse 368 operation produces an LDM that is scale factor s smaller than the output resolution. Upsample and activate 308 can be configured to expand the LDM attributes (depth, density, and blend weights) to the output resolution and activates them. Finally, the LDM layers are over-composited back to front (arrow 324) to produce the rendered image for the novel view.

The layered depth map (LDM) 310 generated at the output of the example network can be used to render the final RGB image. The LDM 310 can include a series of L layers with spatial dimensions [H, W] that are situated within the frustum of the novel viewpoint being rendered, which can be referred to as the target viewpoint. LDM layers have three associated attributes: depths d, densities σ, and blend weights β (see FIG. 3A). The depth and density contain the [L, H, W, 1] depth and transparency (i.e. alpha) values, respectively. The blend weights β contain [L, H, W, M] coefficients for blending M input images on each layer.

To render the target image from an LDM some implementations can first back-project 318 the input images onto the depth layers. The operator

$${θ}_{T}^{} ( I , d )$$

can be defined for this purpose (the transpose here denoting that this is the adjoint of the normal forward projection operator [symbol] that will be introduced below). Here I is an [M, H, W, C] tensor of input images and θ are the camera parameters. The back-projected 318 input images can be blended using the per-image blend weights βₘ to create per-layer RGB. This RGB, along with the density σ, is then over-composited to produce the final image 330. Let [symbol] : (c, σ) [symbol] I be the standard over composite operator, which renders an image by alpha/density compositing the appearance c at each layer from back to front. The resulting render is:

$${c}_{target} = 𝒪 ( {\sum }_{m = 1}^{M} {β}_{m} \cdot {θ}_{T}^{} ( I , d ) , σ ) \qquad 1$$

During training rendering is implemented with standard differentiable components but during inference an optimized renderer that runs at 1080 p resolution in approximately 1.3 ms can be used.

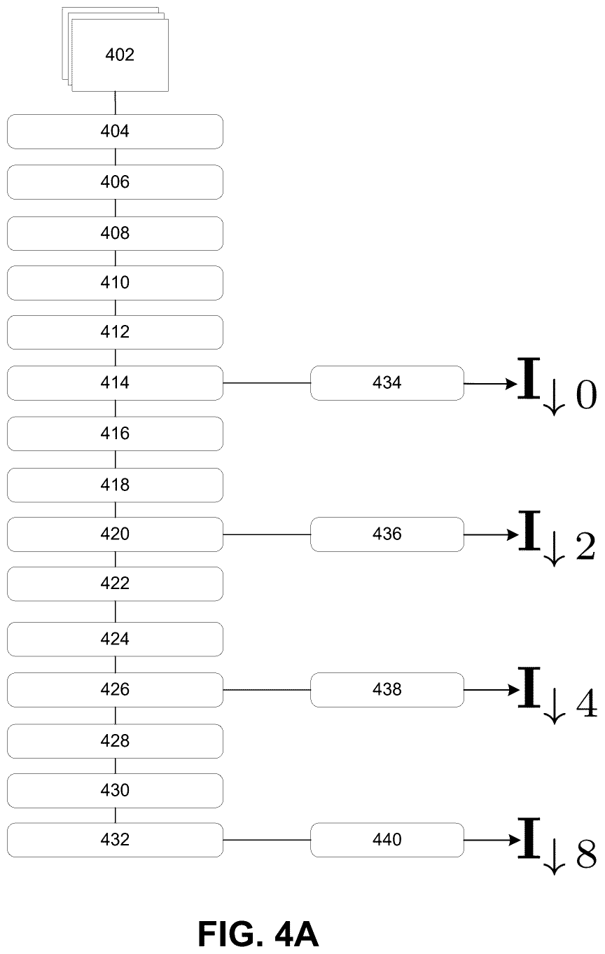

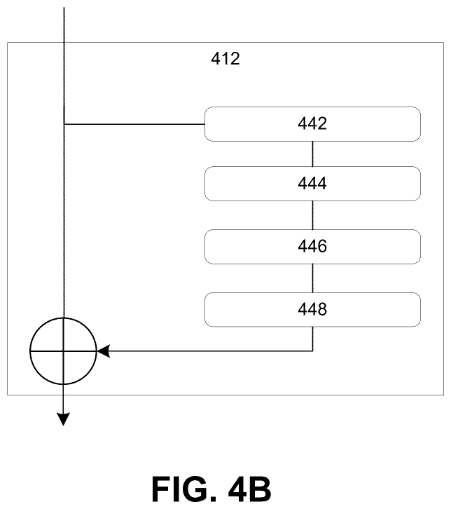

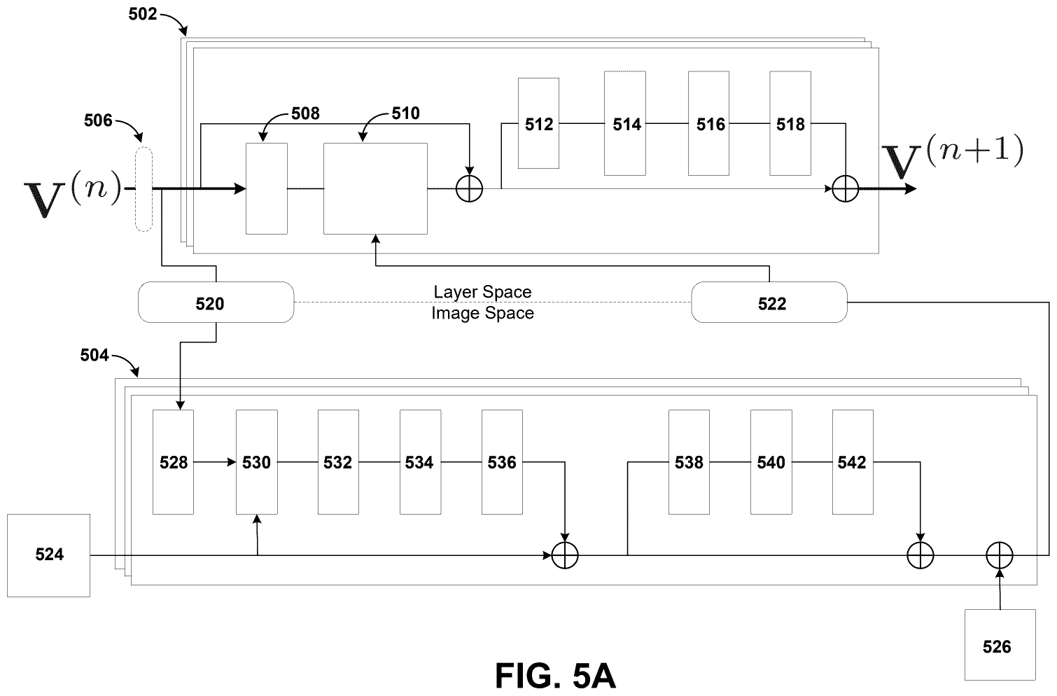

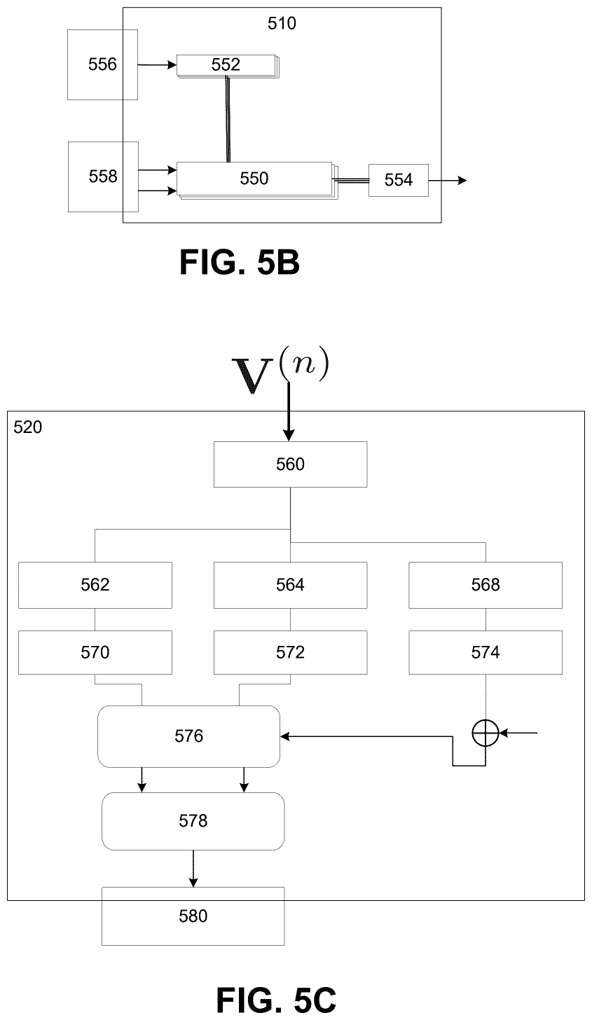

Some implementations describe the model's three major sub-components, with a focus on the iterative multi-scale render-and-refine approach. FIGS. 4A and 4B show the overall network structure, and FIGS. 5A to 5C show the update and fuse operation in detail.

An approach including solving the LDM directly at the final output resolution H, W would be computationally expensive. Instead, some implementations include a method that solves for the final high resolution LDM by first downsampling and encoding M input images, and then iteratively refining the LDM over N render-and-refine update operations that progressively increase spatial resolution while decreasing the number of layers (see bottom row of FIG. 1). This multi-scale approach can influence the speed of the example network. In early iterations computation with more layers is performed at very low spatial resolution, and in later iterations the cost of high spatial resolution is offset by layer reduction.

FIGS. 4A and 4B. Illustrates an example model that encodes and downsamples input images using a series of residual networks and strided mean-pooling layers. As shown in FIG. 4A images 402 (e.g., video 302) are input to an image resize 404 block where the images 402 can be resized (e.g., to a predefined size). In a convolution 406 block the resized images 402 can be convolved. In some implementations, convolution 406 can be, for example, a 7×7 convolution with a stride of 2. In GELU 408 (Gaussian Error Linear Unit) block, the output of the convolution 406 can be activated. In other words, GELU 408 can be configured to calculate the output of convolution 406 based on its individual inputs and their weights. In a convolution 410 block the output of GELU 408 can be convolved. In some implementations, convolution 410 can be, for example, a 3×3 convolution with a stride of 2.

Residual convolution 412, 414, 416 blocks can be feed-forward CNNs configured to generate update features from each of images 402. The output of residual convolution 414 can be input to convolution 434 and convolved to generate images features (e.g., a feature map) I_{↓0}. In some implementations, convolution 434 can be, for example, a 1×1 convolution. The output of convolution 416 can be input to a mean pooling layer 418 block. Mean pooling layer 418 can be configured to reduce the spatial dimensions of the feature map generated by convolution 416 by calculating the average value of each small window or region within the feature map. Pooling can help to downsample the feature map, making the model more robust to aggregate features from a wider receptive field and/or reduce computational complexity.

Residual convolution 420, 422 blocks can be feed-forward CNNs configured to generate update features from each of images 402. The output of residual convolution 420 can be input to convolution 436 and convolved to generate images features (e.g., a feature map) I_{↓2}. In some implementations, convolution 436 can be, for example, a 1×1 convolution. The output of convolution 422 can be input to a mean pooling layer 424 block. Mean pooling layer 424 can be configured to reduce the spatial dimensions of the feature map generated by convolution 422 by calculating the average value of each small window or region within the feature map.

Residual convolution 426, 428 blocks can be feed-forward CNNs configured to generate update features from each of images 402. The output of residual convolution 426 can be input to convolution 438 and convolved to generate images features (e.g., a feature map) I_{↓4}. In some implementations, convolution 438 can be, for example, a 1×1 convolution. The output of convolution 428 can be input to a mean pooling layer 430 block. Mean pooling layer 430 can be configured to reduce the spatial dimensions of the feature map generated by convolution 428 by calculating the average value of each small window or region within the feature map.

Residual convolution 432 block can be feed-forward CNNs configured to generate update features from each of images 402. The output of residual convolution 432 can be input to convolution 440 and convolved to generate images features (e.g., a feature map) I_{↓8}. In some implementations, convolution 440 can be, for example, a 1×1 convolution.

FIG. 4B is a block diagram of a residual convolution according to an example implementation. FIG. 4B is illustrated as being residual convolution 412. However, FIG. 4B can be an example of any of residual convolution 412, 414, 416, 420, 422, 426, 428, and 432. As shown in FIG. 4B, the residual convolution includes a normalization 442 block, a convolution 444 block, a GELU 446 block, and a convolution 448 block. As shown in FIG. 4B, an input feature map (image features) is normalized, convolved, activated, convolved and the resultant feature map (image features) (output of convolution 448) is added to the input feature map (image features) and output to the next layer.

FIGS. 5A, 5B, and 5C illustrate the update and fuse operation. As shown in FIG. 5A, the update and fuse 352, 356, 360, 364, 368 operation includes a fusion 502 block and an update 504 block. The fusion 502 includes a layer collapse 506 block, a normalization 508 block, a one-to-many attention 510 block, a normalization 512 block, a convolution 514 block, a GELU 516 block, and a convolution 518 block. The fusion 502 receives a feature volume V⁽ⁿ⁾ and an updated features A as input and generates an updated feature volume V⁽ⁿ⁺¹⁾ as an output.

The update 504 includes an upsample 528 block, a concatenate 530 block, a convolution 532 block, a GELU 534 block, a convolution 536 block, a convolution 538 block, a GELU 540 block, and a convolution 542 block. The update 504 receives images features 524 (e.g., a feature map) I_{↓k}, an intermediate LDM Ĩ, and ray encoding 526 γ as input and generates updated features Δ as output. The dataflow further includes a back-project 522 block and a render to input views 520 block. The back-project 522 can be used in generating the updated features Δ. The render to input views 520 can be configured to generate the intermediate LDM Ĩ.

FIG. 5B is a one-to-many attention 510 according to an example implementation. As shown in FIG. 5B, the one-to-many attention 510 includes a linear layer 552 block, a scaled dot-product attention 550 block, and a concatenate and linear 554 block. The one-to-many attention 510 receives the feature volume 556 V⁽ⁿ⁾ and the updated features 558 Δ as input. The feature volume 556 can be queried as an input to the linear layer 552. The updated features 558 can include a key and a value as an input to the scaled dot-product attention 550.

FIG. 5C is a render to input views 520 according to an example implementation. As shown in FIG. 5C, the render to input views 520 can include a normalization 560 block, a linear layer 562, 564, 568 blocks, a sigmoid 570 block, a softplus 572 block, a tanh 574 block, a project 576 block, an over-composite 578 block and a rendered features 580 block. The render to input views 520 receives the feature volume V⁽ⁿ⁾ as input and generates rendered features 580 Ĩ (also referred to as intermediate LDM Ĩ).

During each iteration (see FIG. 3B) the update and fuse 352, 356, 360, 364, 368 operation uses a render-and-refine approach to generate a refined feature volume. First, the feature volume is decoded into an LDM and rendered M times into each of the input viewpoints. Next, the rendered features are combined with input features Iₖ and encoded ray directions γₖ via a residual, for example, feed-forward CNN to generate update features from each view. During iterations where the feature volume is upscaled, the rendered intermediate LDM is upsampled by a factor of, for example, two in the spatial dimension and combined with image features at the next level of detail. Updated features are back-projected into the feature volumes using the same depths d decoded in the feature volume decoding operation. Finally, updates from all views are combined into a single set of update features Δ and fed into the fusion block, which uses across-view attention (top inset) to reason about visibility and update the feature volume. Note that multiple Update Blocks and Fusion Blocks are used during each iteration. Layer collapse, which reduces the number of layers by a factor of 2 via, for example, a residual CNN, is also applied during the final two iterations.

The M input images can first be converted to low resolution feature map pyramids (each with K levels) using a convolutional encoder (see FIG. 4A). This encoding operation allows the model to operate at reduced resolutions, rather than on the input images directly. At each update operation n in the solver Some implementations choose the appropriate resolution feature map from these K feature maps. For each image feature map Iₖ Some implementations can encode the direction of image rays relative to the target camera using a ray directional encoding γₖ. The encoded ray directions allow the network to bias towards input views that are closer to the target view, leading to improved results for reflections and non-Lambertian surfaces (as described below). Several methods to encode the ray direction. For example, a sinusoidal positional encoding and/or a spherical harmonics technique can be used.

For Some implementations ray direction encoding can adopt an approach tailored to the specific geometry of the LDM. Some implementations encode a ray by first computing the difference vector between the ray's intersections with the near and far planes of the LDM frustum in projective space. After applying a tanh nonlinearity to this two- dimensional (2D) difference vector, some implementations encode it with a sinusoidal positional encoding. The resulting ray encoding method has several desirable properties. Firstly, it evaluates to zero when an input ray aligns with an LDM (and target view) ray. Secondly, the precision is concentrated on ray directions of interest, namely those intersecting the near and far planes within or close to the LDM frustum bounds. Finally, the tanh nonlinearity ensures that rays falling outside the frustum are still represented, albeit with less precision.

For efficiency, the ray directional encoding is computed once at low resolution and bilinearly upsampled to match the dimensions within the feature map pyramid. Some implementations use, for example, eight (8) octaves of sinusoidal encoding and project the result using a linear layer to C channels. A separate projection matrix can be applied for each required resolution.

The example network then increases from coarse to fine resolution over a series of, for example, five update and fuse operations. During the solve, the LDM is processed in an encoded form V(n) that Some implementations refer to as the feature volume (see FIG. 1). Note that both the number of layers L and spatial resolution of the feature volume can change across the update operations. Some implementations increase the resolution while simultaneously decreasing the number of output layers, reminiscent of, for example, a UNet. The number of channels can be held constant across iterations.

During each iteration, the solver can be configured to call an update and fuse network, shown in expanded detail in FIG. 5A. Each update and fuse can decode V⁽ⁿ⁾ to generate an intermediate LDM, renders this LDM to each of the input views (e.g., render to input views 520), and then combines (in update 504) the rendered LDM Ĩ with its corresponding input image features Iₖ and encoded ray directions ρₖ, selected from the k-level image feature pyramid. Note that the update 504 may include an upsampling of Ĩ if there is a transition between resolutions for this operation. The update 504 then generates update features that are back-projected 522 into the feature volume. This per-view array of update features Δ encodes both extracted image features (hence it bears some similarity to a plane sweep volume) as well as visibility information derived from comparing to Iₖ. The per-view update features are aggregated by fusion 502, which uses one-to-many attention over Δ. The output of the fusion 502 is an update to the encoded LDM V.

To render the intermediate LDM (e.g., render to input views 520), some implementations first decode the feature volume V(n) to instantiate the intermediate LDM. Some implementations decode density and depth in a similar way as for the final LDM. However, for efficiency, some implementations can activate before projecting to the views. Additionally, rather than using blend weights, some implementations instantiate the intermediate LDM's appearance directly via c=sigmoid (VWₐ). When rendering, some implementations project the intermediate LDM layers through the depth map d into each of the input views using the projection operator [symbol] _{θ}: (V, d) [symbol] {I, . . . }, and over-composite the result to yield:

$$\tilde{I} = 𝒪 ( {θ}_{} ( a , d ) , {θ}_{} ( σ , d ) ) \qquad ( 2 )$$

for that input view.

Prior to each of the final two update and fuse 364, 368 operations, some implementations can reduce the number of layers by a factor of two using a residual MLP, where the straight through path is the mean of adjacent layers. This reduction in layers, for a possible small reduction in quality, can reduce computation at these higher resolution iterations.

Initialization of the LDM (initialization 350 in FIG. 3B) can use a special case of the update and fuse 352, 356, 360, 364, 368 operation. Since there is no existing LDM to use as input to the first iteration, some implementations start with a single learned C-channel feature broadcasted to initial spatial dimensions H⁽⁰⁾, W⁽⁰⁾. The first update and fuse 352 operation assumes depth layers are flat (e.g., initialized to the depth anchor values defined below), and thus it only combines image features Iₖ and ray directions γₖ in update 504 in FIG. 5A. In some implementations, the rendered LDM can be omitted during the first iteration.

After the update and fuse 352, 356, 360, 364, 368 operations the feature volume can include the final scene representation, albeit in an encoded form and still at relatively low resolution. The final LDM can be decoded from V(N) using, for example, linear projections followed by non-linear activation functions (upsample and activate 308 in FIG. 3A). For example, density can be decoded using σ=sigmoid (VW_{σ}), where W_{σ} can be linear weights learned by the example network. When some implementations decode depths d, some implementations can constrain the resulting LDM layers to equality spaced disparity bands within the near and far plane of the target view frustum. To do this, some implementations compute depth relative the depth anchors & which are just the center point of each band. Thus for each layer, [symbol] =1, . . . , L:

$$δ = \frac{l - 0.5}{L} \qquad ( 3 )$$

and the final normalized depth d is:

$${d}_{l} = {[ ( δ + \frac{0.5}{L} * tanh ( {VW}_{d} ) ) \cdot ( \frac{1}{η} - \frac{1}{f} ) + \frac{1}{f} ]}^{- 1} \qquad ( 4 )$$

Some implementations compute the blend weights β using the same one-to-many attention mechanism used within fusion 502. However, some implementations can delay applying a vector conversion function (e.g., the softmax function) until after upsampling to the target resolution. This operation can be incorporated into the final fusion 502 operation and uses that operation's image update features ∇.

Substantially all activations can be applied after bilinear upsampling to the final target resolution. For real scenes, depth and density are typically piecewise smooth, and post-sampling activation can generate crisp occlusion boundaries, while blending over the full resolution input images produces high resolution RGB output.

Some implementations include an across-view attention mechanism that fuses the update features Δ to generate an updated feature volume V(n+1) in fusion 502 in FIG. 5A.

Some implementations use a one-to-many attention 510 that aggregates per-view update features ∇ by repeatedly cross-attending from a single aggregated feature to M per-view update features ∇. Intuitively, this attention mechanism (softly) selects the most relevant information from the per-view update features ∇, implicitly incorporating both image matching cues and occlusion. Echoing a transformer's positional encoding, the ray directional encoding included within the update feature allows the network to bias toward rays closer to the target view. Some implementations include a method that inherits cross-attention's O(M) complexity. However, some implementations may show that by exploiting specific redundancies in the transformer's formulation, the constant factor can be reduced for some implementations typical input sizes, leading to a model that is closer to O(1).

Given a set of queries Q, keys K and values Val, the standard attention operation computes the output according to

$$Attention ( Q , K , Val ) := softmax ( \frac{{QK}^{T}}{\sqrt{C}} ) Val \qquad ( 5 )$$

where C is the number of channels.

The full transformer can use multi-headed attention where the query, keys and values are each projected to h multiple heads, each with C/h channels, before performing h attention queries. The resulting values can then be concatenated and projected to the final output. This operation can be performed multiple times, interleaved with MLP blocks. In order to perform view feature aggregation within an example network, the current V cross- attends over the M update features ∇. In standard cross-attention the queries and keys for the different attention heads can be derived by linear projection from both of these values. That is,

$$MultiHead ( V , ∇ ) = concat ( {head}_{1} , … , {head}_{h} ) {W}^{O} \qquad ( 6 )$$

with

$${head}_{i} = Attention ( {VW}_{i}^{q} , ∇ {W}_{i}^{k} , ∇ {W}_{i}^{val} ) \qquad ( 7 )$$

and W^{o} the output projection.

The standard multi-headed attention operation can require h×M matrix multiplies, each of size C×C/h, to multiply the ∇s with

$$∇ {W}_{i}^{k} and ∇ {W}_{i}^{val} .$$

However, there can be a redundancy in the standard attention formulation. For example, under certain conditions it is mathematically equivalent but much more efficient to omit the matrix multiplies on ∇ and instead fold them into

$${VW}_{i}^{q}$$

and WO, leading to une following formulation:

$${head}_{i} = Attention ( {VW}_{i}^{q} , ∇ , ∇ ) \qquad ( 8 )$$

This can remove substantially all of the matrix multiplies to produce the M keys and values, leaving only the dot products and sums. Additionally, some implementations can gain further efficiency by reducing expensive layer-space computation. Standard cross attention would require repeated (for multiple attention rounds) matrix multiplies over the M per-view update features ∇ on each of each of the L×H×W LDM elements, which can require O(LM) matrix multiplies per element. In contrast, an example optimized one-to-many attention method can eliminate the need for any matrix multiplications on the update features within layer-space (e.g., O(LM) matrix multiplies), thus shifting most of the per-view computation to image space (e.g., O(M) matrix multiplies).

A pre-LayerNorm (layer normalization) transformer can include residual self-attention blocks followed by residual MLP blocks. Some implementations can include mirroring that formulation, and define the full one-to-many attention block, including normalization, [symbol] , as

$${V}^{′} = V + MultiHead ( ( V ) , ∇ ) \qquad ( 9 )$$

Mirroring a transformer's MLP block, the one-to-many attention module can be interleaved with 2D 3×3 convolutional blocks:

$${V}^{′} = V + Conv ( gelu ( Conv ( ( V ) ) ) ) \qquad ( 10 )$$

The full view fusion 502 can include one-to-many attention 510 and convolution 514, 518 learns to both aggregate across views and to constrain the LDM to the manifold of real scenes.

Similar to other generalizable view synthesis methods, some implementations can include training on a collection of calibrated multi-view images across a variety of scenes. For example, the network can be trained with 8 input images rendered to a held-out target image. Some implementations can include training the model using a combined 10*L1+LPIPS loss function, with batch size 16 across a single 16 GPU. Some implementations train an example model for 250K iterations on half resolution input images, with a similarly half resolution encoded LDM, before increasing to full resolution for 350K steps, for a total of 600K steps. To reduce RAM consumption some implementations can include training to randomly crop the target and rendered image to size 256×256 during initial low resolution training and 512×512 pixels during high res training. The learning rate can be warmed up to 1.5×10−4 over 20k iterations, held constant for 520K iterations and then cosine-decayed to zero over the final 680K iterations. Some implementations use residual scaling throughout the example model to improve stability.

Some implementations trained example models on a weighted combination of, for example, the Spaces, RFF, Nex-Shiny, and SWORD datasets. Substantially all datasets had equally weighted apart from the much smaller Nex-Shiny dataset which was weighted at 0.25. These datasets can have different image resolutions, so for each example some implementations adjust the aspect ratio of the internal LDM dimensions within the example model, accordingly, retaining the same total area per layer and thus the same computational requirements as an example 1080 p model. Similarly, some implementations chose a different near and far plane adaptively for each example, based on the distribution of depths from the available reconstructed SFM points.

Two variants of the example model can be trained:
A first model can start from an initial LDM resolution of 64×36 and 24 layers and reduce the layers while increasing the spatial resolution to produce an output LDM of resolution 512×288 with 6 layers.
A second model, in contrast, can start from an initial LDM resolution of 96×54 and 32 layers and produces an output LDM of resolution 768×438 with 8 layers.

Both can be targeted to a 1080 p (1920×1080) image size. To reach this final output resolution the final upsampling factor (during Upsample Activate) can be, for example, 3.75x and 2.4x for the first model and the second model, respectively. The two variants also differ slightly in terms of their architectural details. See enclosed Tables.

Some implementations introduce a novel neural model for fast, high resolution, and high-quality novel view synthesis. Some example models employ several optimizations to achieve real-time rates for combined scene reconstruction and rendering. Some implementations perform intermediate computations at low-resolution. Some implementations use an encoded LDM representation, which is iteratively rendered to the input views and refined via update and view fusion modules. Additional efficiency improvements can come from an optimized one-to-many attention operation to incorporate information from multiple input views during view fusion, and layer collapse which reduces the number of layers as the spatial resolution of the intermediate LDM increases. Some implementations demonstrate state-of-the-art quality across a wide variety of test scenes. Some implementations outperform other generalizable view synthesis approaches on standard static and dynamic datasets, and either outperform or are competitive with even non-generalizable approaches that perform per-scene optimization. Altogether, in some implementations the example model enables fully feed-forward novel view synthesis from a set of input cameras at up to 2K resolution, performing both scene reconstruction and rendering at real-time rates.

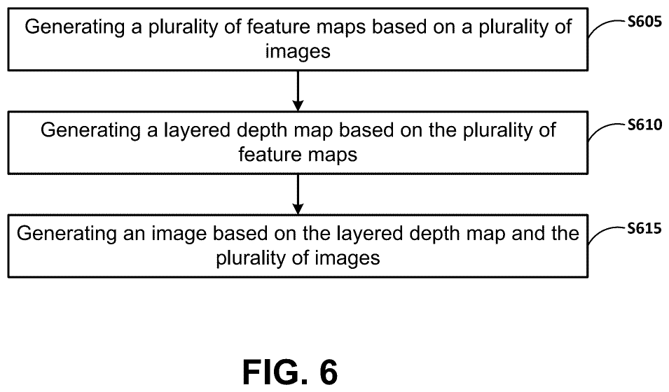

Example 1. FIG. 6 is a block diagram of a method of generating an image according to an example implementation. As shown in FIG. 6, in step S605 generating a plurality of feature maps based on a plurality of images plurality of images triggered to capture at the same time. In step S610 generating a layered depth map based on the plurality of feature maps. In step S615 generating an image based on the layered depth map and the plurality of images, the image having a view perspective not included in the plurality of view perspectives. In some implementations, the plurality of images can have a plurality of view perspectives. In some implementations, the plurality of images can be triggered to capture substantially simultaneously. In some implementations, the plurality of images can be triggered to capture simultaneously. In some implementations, the plurality of images can be captured substantially at the same time. In some implementations, the plurality of images can be captured at the same time. In some implementations, the plurality of images can be captured substantially simultaneously. In some implementations, the plurality of images can be captured simultaneously. For example, the system including the plurality of cameras can trigger the sending of an instruction to a plurality of cameras at substantially the same time. The instruction can cause each of the plurality of cameras to capture an image. Accordingly, the plurality of cameras can be configured to capture a plurality of images at the same time based on the trigger.

Example 2. The method of Example 1, wherein generating the plurality of feature maps can include encoding and downsampling the plurality of images.

Example 3. The method of Example 1, wherein the plurality of feature maps can be a feature pyramid, and the feature pyramid can be a structured arrangement of feature maps having multiple scales.

Example 4. The method of Example 1, wherein generating the layered depth map can include iteratively decoding the plurality of feature maps and iteratively generating an intermediate layered depth map based on the decoded plurality of feature maps.

Example 5. The method of Example 4, wherein two or more of the decoded plurality of feature maps can have different volumetric dimensions.

Example 6. The method of Example 4, wherein generating the layered depth map can include upsampling the intermediate layered depth map and activating the upsampled layered depth map using a non-linear activation function.

Example 7. The method of Example 1, wherein generating the layered depth map can include iteratively refining the layered depth map from a low resolution to a high resolution while reducing a number of layers associated with the layered depth map.

Example 8. The method of Example 1, wherein generating the image can include blending the plurality of images using a weight associated with the layered depth map.

Example 9. The method of Example 1, wherein the layered depth map can include a plurality of layers with spatial dimensions including the view perspective.

Example 10. The method of Example 1, wherein generating the image includes projecting the plurality of images onto layers of the layered depth map.

Example 11. A method can include any combination of one or more of Example 1 to Example 10.

Example 12. A non-transitory computer-readable storage medium comprising instructions stored thereon that, when executed by at least one processor, are configured to cause a computing system to perform the method of any of Examples 1-11.

Example 13. An apparatus comprising means for performing the method of any of Examples 1-11.

Example 14. An apparatus comprising at least one processor and at least one memory including computer program code, the at least one memory and the computer program code configured to, with the at least one processor, cause the apparatus at least to perform the method of any of Examples 1-11.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The operations are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

What is claimed is:

1. A method comprising:
generating a plurality of feature maps based on a plurality of images triggered to capture at a same time, the plurality of images having a plurality of view perspectives;
generating a layered depth map based on the plurality of feature maps; and
generating an image based on the layered depth map and the plurality of images, the image having a view perspective not included in the plurality of view perspectives.

2. The method of claim 1, wherein
generating the plurality of feature maps includes encoding and downsampling the plurality of images.

3. The method of claim 1, wherein
the plurality of feature maps is a feature pyramid, and
the feature pyramid is a structured arrangement of feature maps having multiple scales.

4. The method of claim 1, wherein generating the layered depth map includes
iteratively decoding the plurality of feature maps, and
iteratively generating an intermediate layered depth map based on the decoded plurality of feature maps.

5. The method of claim 4, wherein two or more of the decoded plurality of feature maps have different volumetric dimensions.

6. The method of claim 4, wherein generating the layered depth map includes
upsampling the intermediate layered depth map, and
activating the upsampled layered depth map using a non-linear activation function.

7. The method of claim 1, wherein generating the layered depth map includes iteratively refining the layered depth map from a low resolution to a high resolution while reducing a number of layers associated with the layered depth map.

8. The method of claim 1, wherein generating the image includes
blending the plurality of images using a weight associated with the layered depth map.

9. The method of claim 1, wherein the layered depth map includes a plurality of layers with spatial dimensions including the view perspective.

10. The method of claim 1, wherein generating the image includes projecting the plurality of images onto layers of the layered depth map.

11. An apparatus comprising at least one processor and at least one memory including computer program code, the at least one memory and the computer program code configured to, with the at least one processor, cause the apparatus to:
generate a plurality of feature maps based on a plurality of images triggered to capture at a same time, the plurality of images having a plurality of view perspectives;
generate a layered depth map based on the plurality of feature maps; and
generate an image based on the layered depth map and the plurality of images, the image having a view perspective not included in the plurality of view perspectives.

12. The apparatus of claim 11, wherein
generating the plurality of feature maps includes encoding and downsampling the plurality of images.

13. The apparatus of claim 11, wherein
the plurality of feature maps is a feature pyramid, and
the feature pyramid is a structured arrangement of feature maps having multiple scales.

14. The apparatus of claim 11, wherein generating the layered depth map includes
iteratively decoding the plurality of feature maps, and
iteratively generating an intermediate layered depth map based on the decoded plurality of feature maps.

15. The apparatus of claim 14, wherein
two or more of the decoded plurality of feature maps have different volumetric dimensions, and
generating the layered depth map includes
upsampling the intermediate layered depth map, and
activating the upsampled layered depth map using a non-linear activation function.

16. The apparatus of claim 11, wherein generating the layered depth map includes iteratively refining the layered depth map from a low resolution to a high resolution while reducing a number of layers associated with the layered depth map.

17. The apparatus of claim 11, wherein generating the image includes
blending the plurality of images using a weight associated with the layered depth map.

18. The apparatus of claim 11, wherein the layered depth map includes a plurality of layers with spatial dimensions including the view perspective.

19. The apparatus of claim 11, wherein generating the image includes projecting the plurality of images onto layers of the layered depth map.

20. A non-transitory computer-readable storage medium comprising instructions stored thereon that, when executed by at least one processor, are configured to cause a computing system to:
generate a plurality of feature maps based on a plurality of images triggered to capture at a same time, the plurality of images having a plurality of view perspectives;
generate a layered depth map based on the plurality of feature maps; and
generate an image based on the layered depth map and the plurality of images, the image having a view perspective not included in the plurality of view perspectives.
